(19) United States
(12) Patent Application Publication
(10) Pub. No.: US 2017/0081542 A1
(43) Pub. Date: Mar. 23, 2017

(54) Method for Coating Metal Surfaces of Substrates and Objects Coated in Accordance With Said Method

(71) Applicant: CHEMETALL GMBH, Frankfurt am Main (DE)

(72) Inventors: Wolfgang BREMSER, Paderborn (DE); Martin DROLL, Schlangen (DE); Oliver SEEWALD, Marsberg (DE); Evgenija NIESEN-WARKENTIN, Soest (DE); Lars SCHACHTSIEK, Paderborn (DE); Manuel TRAUT, Hamm (DE); Michael SCHWAMB, Frankfurt (DE); Daniel WASSERFALLEN, Mainz (DE); Vera SOTKE, Schwalbach am Taunus (DE); Aliaksandr FRENKEL, Offenbach (DE); Ron EILINGHOFF, Frankfurt (DE); Stephanie GEROLD, Paderborn (DE)

(73) Assignee: CHEMETALL GMBH, Frankfurt am Main (DE)

(21) Appl. No.: 15/310,899

(22) PCT Filed: May 12, 2015
(86) PCT No.: PCT/EP2015/060461

§ 371 Date: Nov. 14, 2016

(30) Foreign Application Priority Data
May 14, 2014 (DE) 10 2014 209 083.0

(51) Int. Cl. C09D 105/06; C25D 5/34; C23C 22/74; C25D 9/02; C09D 5/08; C23C 22/34

(52) U.S. Cl. CPC C09D 105/06; C09D 5/08; C23C 22/34; C23C 22/74; C25D 9/02; C25D 5/34

(57) ABSTRACT

The invention relates to a method for coating surfaces, to a corresponding coating, and to the use of the objects coated in accordance with said method. In accordance with the invention the object is achieved by a method for coating metallic surfaces of substrates that comprises or consists of the following steps: I) providing a substrate having a cleaned metallic surface, II) contacting and coating metallic surfaces with an aqueous composition in dispersion and/or suspension form, III) optionally rinsing the organic coating, and IV) drying and/or baking the organic coating or V) optionally drying the organic coating and coating it with a similar or further coating composition prior to drying and/or baking, characterized in that the coating in step II is carried out with an aqueous composition in dispersion and/or suspension form that comprises a complex fluoride, and at least one anionic polyelectrolyte is added to a nonionically or anionically/nonionically stabilized dispersion of film-forming polymers and/or to a suspension of film-forming inorganic particles and a coating forms that is based on an ionogenic gel comprising cations dissolved out of the metallic surface.

The invention relates to a method for coating surfaces, a corresponding coating and the use of the objects coated in accordance with this method. There are numerous methods for creating homogenous coatings on metallic surfaces by means of immersion methods in particular. These methods use techniques described preferably in the following description for creating corrosion-preventing coatings consisting primarily of an organic matrix and/or organic and/or inorganic additive components.

The traditional methods are based on use of the rheological properties of the formulations used in order to achieve a complete coating of a structured workpiece. Although an accumulation of coating material in critical locations can be reduced by continuous rotation of the respective workpiece after the immersion process, it is impossible with this method to achieve a completely homogeneous coating. In addition, defects such as blisters and blistering may develop in locations of larger amounts of coating during the drying and/or crosslinking processes and have a negative effect on the quality of the entire coating.

Electrophoretic methods avoid these problems by using electrical current to deposit a uniform coating during immersion. With this method it is possible to create homogenous coatings on metallic workpieces. The deposited coatings have an extremely good adhesion in the wet state to the metallic substrate. Without removing the coating, it is possible to treat the workpiece in a subsequent rinsing step. This results in the aforementioned sparingly accessible locations on the workpiece being freed of the excess coating solution, and therefore no defects can develop during the drying process. This technique has the disadvantage that, in addition to the amount of electricity consumed and the required immersion basin, resulting in higher costs, so-called thinning at the edges occurs because inhomogeneous electric fields are built up on macroscopic edges, which are then coated irregularly and possibly incompletely. In the construction of the workpieces, cavities must also be avoided because an effect comparable to the phenomenon of a Faraday cage occurs at these locations. Because of the reduction in the electrical field strength required for this deposition, no coating or only a greatly reduced coating can be applied to the workpiece by this method in such regions (reach-around problem), which has a negative effect on the quality of the coating. In addition, this technique has the following disadvantages in electro-dip coating (EDC), such as cathodic electro-dip coating (CDC), for example: a corresponding electro-dip coating bath is very complicated and expensive to construct, not to mention all the electrical and mechanical equipment, from temperature control, power supply and electrical insulation, circulating equipment and feed equipment to disposal of the anolyte acid, which is formed in electrolytic coating and also ultrafiltration, to paint recycling as well as the control equipment. The process management also requires a very high technical expenditure because of the high amperage and high energy consumption as well as in equalizing the electrical parameters over the bath volume and in precise adjustment of all process parameters as well as in maintenance and cleaning of the installation.

The known autophoretic methods are based on a currentless concept, consisting of a pickling attack on the substrate surface used, in which metal ions are dissolved out of the surface and the emulsion coagulates because of the concentration of metal ions at the resulting interface. Although these methods do not have the aforementioned restriction of the electrolytic methods with regard to the Faraday cage effect, the coatings formed in this process must be fixed in a complex multistage immersion process after the first activation step. In addition, the pickling attacks results in an unavoidable contamination of the active zone with metal ions that must be removed from the zones. Furthermore this method is based on a chemical deposition process which is not self-regulating and cannot be terminated on demand such as, for example, by shutting down the electric current in the electrolytic method. Thus with a longer dwell time of the metallic substrates in the active zones, the development of an excessively great layer thickness is unavoidable.

A wish that has long been pursued is to form homogenous coatings efficiently and inexpensively in an immersion process to produce essentially planar coatings that have the greatest possible thickness and are as closed as possible.

Therefore the object is to propose a method with which a paint formulation can be deposited on metallic surfaces homogenously, with good coverage and by a simple method, using a liquid system, which is also rinse-resistant if necessary. Another object was to propose the simplest possible method of accomplishing this.

This object is achieved with a method for coating metal surfaces of substrates comprising or consisting of the steps:
I. Providing a substrate with a cleaned metallic surface,
II. Contacting and coating metallic surfaces with an aqueous composition in the form of a dispersion and/or suspension,
III. Optionally rinsing the organic coating and
IV. Drying and/or baking the organic coating or
V. Optionally drying the organic coating and applying a coating using a similar coating composition or another coating composition prior to drying and/or baking,

wherein the coating is applied with an aqueous composition in the form of a dispersion and/or suspension in step II containing a complex fluoride selected from the group consisting of hexa- or tetrafluorides of the elements titanium, zirconium, hafnium, silicon, aluminum and/or boron in an amount of 1.1.10⁻⁶ mol/liter to 0.30 mol/liter, based on the cations, wherein at least one polyelectrolyte is added in an amount of 0.01 to 5.0% by weight, based on the total weight of the resulting mixture to a nonionically or anionically-nonionically stabilized dispersion of film-forming polymers and/or a suspension of film-forming inorganic particles having a solids content of 2 to 40% by weight and an average particle size of 10 to 1000 nm, which is stable in a pH range of 0.5 to 7.0, wherein the aqueous composition has a pH in the range of 0.5 to 7.0 and forms a coating based on an ionogenic gel, which binds the cations dissolved out of the metallic surface, wherein these cations originate from a pretreatment stage and/or from the contacting in step II. The term “electrosterically stabilized dispersion” is also used as synonymous for the concept of an “anionically-nonionically stabilized dispersion” in a sense of the present invention. The inventive addition of complex fluorides leads to extensively homogenous coatings with dry layer thicknesses in the range of 20 μm to 100 μm on galvanized steel plate and to dry layer thicknesses>1 μm on cold rolled steel plate or aluminum. For the nonionic dispersion, a greater corrosion protection by a factor of up to 10 in comparison with the coating method known from the state of the art based on ionic coatings has surprisingly been found.

The complex fluoride is preferably used in an amount of 1.1.10⁻⁵ mol/liter to 0.15 mol/liter preferably 1.1.10⁻⁴ mol/liter to 0.05 mol/liter, based on the cations, wherein the aqueous composition has a pH in the range of 1.0 to 6.0, especially preferably 1.5 to 5.0.

The coating according to the invention has a single-layer structure, in which either a more or less homogenous coating is formed and/or may be present or there may be a coating, in which the particles accumulate to a somewhat greater extent close to the metallic surface.

Substrates having a metallic surface to be coated in this way are understood according to the invention to include metals, surfaces with metallic coatings or metal surfaces pretreated with primers out of which metal cations can still be dissolved. The term “surface(s) to be coated” in the sense of this patent application comprises in particular surfaces of metallic objects and/or metallic particles which may optionally be precoated with a metallic coating, for example, such as one based on zinc or a zinc alloy and/or with at least one coating of a treatment or pretreatment composition, for example, based on chromate, Cr³⁺, Ti compound, Zr compound, silane/silanol/siloxane/polysiloxane and/or organic polymer.

The metallic materials fundamentally include all types of metallic materials, in particular those made of aluminum, iron, copper, titanium, zinc, magnesium, tin and/or alloys containing aluminum, iron, calcium, copper, magnesium, nickel, chromium, molybdenum, titanium, zinc and/or tin, wherein these materials may also be used in proximity to one another and/or one after the other. The surfaces of the material may optionally also be precoated with zinc or an alloy containing aluminum and/or zinc, for example.

The objects to be coated may be basically all types of objects made of a metallic material or provided with at least one metallic coating, in particular metal-coated polymer materials or fiber-reinforced polymer materials, for example, small parts, joined components, components with complicated shapes, profiles, rods and/or wires.

The term “currentless coating” in the sense of this patent application means that in coating with a composition containing a solution or dispersion (=suspension and/or emulsion), in contrast with the known electrolytic methods for producing the follow-up coating, an electrical voltage of less than 100 V is applied from the outside.

The invention preferably relates to a method, in which at least one polyelectrolyte is selected from the groups a) polysaccharides based on glycogens, amyloses, amylopectins, calloses, agar, algines, alginates, pectins, carrageenan, celluloses, chitins, chitosans, curdlans, dextrans, fructans, collagens, gellan gum, gum arabic, starches, xanthans, gum tragacanth, karayans, tara gum and glucomannans; b) of natural origin based on polyamino acids, collagens, polypeptides, lignins and/or c) synthetic anionic polyelectrolytes based on polyamino acids, polyacrylic acids, polyacrylic acid copolymers, acrylamide copolymers, lignins, polyvinyl sulfonic acid, polycarboxylic acids, polyphosphoric acids or polystyrenes.

The method according to the invention is preferably one in which the aqueous composition and/or the organic coating produced from it contains at least one type of cations selected from those based on cationic salts selected from the group consisting of melamine salts, nitroso salts, oxonium salts, ammonium salts, salts with quaternary nitrogen cations, salts of ammonium derivatives and metal salts of Al, B, Ba, Ca, Cr, Co, Cu, Fe, Hf, In, K, Li, Mg, Mn, Mo, Na, Nb, Ni, Pb, Sn, Ta, Ti, V, W, Zn and/or Zr.

The term “copolymer” in the sense of this patent application describes polymers comprised of two or more different types of one or more units. Copolymers here can be subdivided into five classes which will be illustrated now on the basis of a binary copolymer made up of two different comonomers A and B: 1. Random copolymers, in which the distribution of the two monomers in the chain is random (AABABBBABAABBBABBABAB . . . );

2. Gradient copolymers, which are in principle like the random copolymers but contain variable amounts of a monomer in the course of the chain (AAAAAABAABBAABABBBAABBBBBB);

3. Alternating or differing copolymers with a regular arrangement of monomers along the chain (ABABABABABABABABABAB . . . );

4. Block copolymers comprised of longer sequences or blocks of each monomer (AAAAAAAAABBBBBBBBBBBB . . . ), where we also speak of diblock copolymers, triblock copolymers and multiblock copolymers, depending on the number of blocks;

5. Graft copolymers, in which blocks of a monomer are grafted onto the backbone of another monomer.

The term “derivatives” in the sense of this patent application denotes a derived substance with a structure similar to that of a corresponding basic substance. Derivatives are substances in which the molecules have a different atom or a different atomic group instead of a hydrogen atom or a functional group and/or in which one or more atoms/atomic groups have been removed.

The term “polymer(s)” in the sense of this patent application denotes monomer(s), oligomer(s), polymer(s), copolymer(s), block copolymer(s), graft copolymer(s) or mixtures thereof and their compounds on an organic or essentially organic basis. The “polymer(s)” in the sense of this patent application is (are) primarily or entirely present as polymer(s) and/or copolymer(s).

The method according to the invention is especially preferably a method in which the aqueous composition and/or the organic coating produced from it contains organic particles based on polyacrylates, polyurethanes, polyepoxides and/or hybrids thereof.

So-called polyacrylate-polyurethane hybrid resins may be differentiated according to type into hybrid systems, created by simply mixing the different dispersions (blends or formulations), systems having a chemical bond between the different types of polymers and those in which the different classes of polymers form interpenetrating networks (IPN).

Such polyurethane-polyacrylate hybrid dispersions are usually prepared by emulsion polymerization of a vinyl polymer (“polyacrylate”) in an aqueous polyurethane dispersion. However it is also possible to produce the polyurethane-polyacrylate hybrid dispersion as a secondary dispersion.

Aqueous polyacrylate polyepoxy hybrid dispersions are usually prepared by addition reactions of a bifunctional epoxy with bifunctional amine monomer building blocks and a subsequent reaction with a polyacrylate having sufficient carboxyl functions. Water dispersibility can be achieved, for example, by carboxylate groups, which have been converted to anionic groups with amines and then dispersed in water, as is the case with the secondary polyurethane dispersions, for example.

Hybrid dispersions for forming a layer on the substrate may preferably also contain organic polymers and/or copolymers based on polyvinyl alcohols, polyvinyl acetates, polybutyl acrylates and/or other acrylic acid esters, in addition to polyurethane and polyepoxy constituents. Acrylic acid esters are esters derived from acrylic acid (CH₂═CH—COOH) and thus having the functional group (CH₂═CH—COOR). In large quantities, acrylic acid methyl esters, acrylic acid ethyl esters, acrylic acid butyl esters and ethyl hexyl acrylate, among others, are produced in large quantities. The main application of acrylic acid esters is in homo- and copolymers including, for example, acrylic acid, acrylamides, methacrylates, acrylonitrile, fumaric acids, itaconic acid, maleates, vinyl acetate, vinyl chloride, styrene, butadiene and unsaturated polyesters, polyepoxy esters, polyacrylamides, polyacrylic acids, polycarbonates, polyesters, polyethers, polystyrene butadienes, poly(meth)acrylic acid esters, polyvinyl acetate copolymers with acrylic acid esters and/or copolymers with dibutyl maleate and/or with vinyl esters of at least one Koch acid, polyethylenes, polyvinyl chlorides, polyacrylonitriles, polyepoxies, polyurethanes, polyacrylates, polymethacrylates, polyesters, polyamides, poytetrafluoroethylenes, polyisobutadienes, polyisoprenes, silicones, silicone rubbers and/or their derivatives. These are in particular present in amounts of at least 50% by weight of the solids and active ingredients in the aqueous composition.

The term “pretreatment” denotes a treatment (=bringing the surfaces to be coated in contact with a composition, usually liquid) in which subsequently, optionally after a subsequent coating, another coating is applied to protect the layer sequence and the object such as, for example, at least one enamel.

In a previous pretreatment before activation of a surface with an activating agent that should help to electrostatically charge up the surface, the surfaces to be treated may first be subjected to an alkaline cleaning as needed and optionally brought in contact with a composition for the pretreatment, the latter to form in particular a conversion layer. The surfaces treated and/or coated in this way may then optionally be coated with a primer and/or with an optionally formable protective layer, in particular coated with an anticorrosion primer and/or optionally oiled. Oiling serves in particular to provide temporary protection for the treated metal surfaces and/or in particular coated metal surfaces.

Basically, any type of pretreatment is possible as the pretreatment. For example, aqueous pretreatment compositions based on phosphates, phosphonates, silanes/silanols/siloxanes/polysiloxanes, lanthanide compounds, titanium compounds, hafnium compounds, zirconium compounds, acids, metal salts and/or organic polymers may be used.

In the further treatment of these coated substrates, an alkaline cleaning may be carried out in particular as needed, regardless of whether or not oil has previously been applied.

A coating with an anticorrosion primer, such as a welding primer may permit additional corrosion protection in particular in cavities and difficultly accessible sections of a substrate, reshapeability and/or joinability, for example, in folding, gluing and/or welding. In industrial practice, an anticorrosion primer could be used in particular when the substrate coated with it, such as sheet metal, for example, is shaped after being coated with the anticorrosion primer and/or is joined to another component and additional coatings are applied only after that. If an anticorrosion primer is additionally applied beneath the activation layer and beneath the particle coating in this operation, then a definitely improved corrosion protection is usually achieved.

The phrase “essentially dishwasher safe” in the sense of this patent application means that the respective last coating is not removed completely by a dishwashing operation (=dishwashing) under the conditions of the respective installation and process sequence, so that a coating, preferably a closed coating, can be produced.

In the method according to the invention, the different types of particles, particle sizes and particle shapes may be used as the particles.

The particles in the aqueous composition for forming the layer may preferably include oxides, hydroxides, carbonates, phosphates, phosphosilicates, silicates, sulfates, organic polymers including copolymers and their derivatives, waxes and/or compounded particles, in particular those based on anticorrosion pigments, organic polymers, waxes and/or compounded particles and/or the mixtures thereof. They preferably have particle sizes in the range of 5 nm to 15 μm, preferably from 20 nm to 1 μm, especially preferably from 50 nm to 500 nm. They are preferably water-insoluble particles.

Compounded particles have a mixture of at least two different substances in one particle. Compounded particles may often have other substance with very different properties. They may contain partially or entirely the composition for a paint, optionally even with a non-particulate substance content, such as surfactants, foam suppressants, dispersants, painting aids, additional types of additives, pigments, corrosion inhibitors, weakly water-soluble anticorrosion pigments and/or other substances that are customary and are known for the corresponding mixtures. Such paint constituents may be suitable and/or frequently used, for example, for organic coatings for forming, for anticorrosion primers and other primers, for pigmented enamels, fillers and/or clear enamels.

An anticorrosion primer usually contains electrically conductive particles and can be welded electrically. In general it is often preferable here for a) a mixture of chemically and/or physically different particles, b) particles, aggregates and/or agglomerates of chemically and/or physically different particles and/or c) compounded particles to be used in the composition and/or in the particle layer formed therefrom.

It is often preferable for the composition containing the particles and/or the particle layer formed therefrom to contain, in addition to at least one type of particle, also at least one non-particulate substance, in particular additives, dyes, corrosion inhibitors and/or weakly water-soluble anticorrosion pigments. The particles in the composition and/or in the particle layer formed from it may in particular be a limited amount of electrically conductive particles, in particular based on fullerenes and other carbon compounds with graphite-like structures and/or carbon black, optionally also nanocontainers and/or nanotubes. On the other hand, coated particles, chemically and/or physically modified particles, core-shell particles, compounded particles comprised of various substances, encapsulated particles and/or nanocontainers may also be used here in particular as particles in the composition and/or in the coating formed therefrom.

With the method according to the invention, it is preferable for the composition containing the particles to contain the particle layer formed therefrom and/or the coating formed therefrom, for example, by forming a film and/or crosslinking, and to additionally contain at least one dye, a dye fragment, an anticorrosion pigment, a corrosion inhibitor, a conductivity pigment, another type of particles, a silane/silanol/siloxane/polysiloxane/silazane/polysilazane, an additive and/or a paint additive, such as at least one surfactant, foam suppressant and/or dispersant, in addition to at least one type of particle.

In the method according to the invention, it is preferable for the composition and/or the coating formed from it to partially or completely comprise a chemical composition for primer, a paint such as a filler, a top coat and/or a clear coat, in addition to at least one type of particles, in addition to at least one non-particulate substance.

Recommended additives to the organic polymers of the particles include in many embodiments pigments and/or additives such as those used frequently in paints and/or primers.

The formation of a film can be improved by using thermoplastic polymers and/or by adding substances that serve as temporary plasticizers. Film-forming aids act as specific solvents which soften the surface of the polymer particles and thereby make it possible to fuse the particles. In this way it is advantageous if these plasticizers on the one hand remain in the aqueous composition for a sufficiently long period of time to be able to have an effect on the polymer particles and then evaporate and thus escape from the film. Furthermore it is advantageous if a residual water content is also present tor a sufficiently long time during the drying process.

So-called long-chain alcohols, in particular those with 4 to 20 carbon atoms such as the following are advantageous in particular as film-forming aids:

a butanediol,

a butyl glycol,

a butyl d glycol,

an ethylene glycol ether such as

ethylene glycol monobutyl ether,

ethylene glycol monoethyl ether,

ethylene glycol monomethyl ether,

ethyl glycol propyl ether,

ethylene glycol hexyl ether,

diethylene glycol methyl ether,

diethylene glycol ethyl ether,

diethylene glycol butyl ether,

diethylene glycol hexyl ether or a

polypropylene glycol ether such as

propylene glycol monomethyl ether,

dipropylene glycol monomethyl ether,

tripropylene glycol monomethyl ether,

propylene glycol monobutyl ether,

dipropylene glycol monobutyl ether,

tripropylene glycol monobutyl ether,

propylene glycol monopropyl ether,

dipropylene glycol monopropyl ether,

tripropylene glycol monopropyl ether,

propylene glycol phenyl ether,

trimethylpentanediol diisobutyrate,

a polytetrahydrofuran,

a polyether polyol and/or a polyester polyol.

Crosslinking may take place, for example, with certain reactive groups such as isocyanate groups, isocyanurate groups and/or melamine groups, for example.

The follow-up coating is preferably dried in such a way that any organic polymer particles that are present in particular can form a film so that a largely or completely homogenous coating is formed. The dry temperatures may be selected to be so high in many embodiments that the organic polymer constituents are able to crosslink.

With the method according to the invention, it is preferable in some embodiments that a particle layer containing essentially organic particles is formed in some embodiments and then a film is formed during drying, for example, and/or the layer is crosslinked. The film is also formed in some embodiments even in the absence of film-forming aids. In these cases the particles of the coating, in particular when they are present primarily or entirely as organic polymers, are preferably first essentially closed or a film is formed as a closed coating, in particular in drying. It is often preferable for the drying temperature of a coating which consists primarily or entirely of organic polymers to be selected so that a closed or essentially closed coating is formed. If necessary at least one film-forming aid may be added for the purpose of forming a film, in particular such an aid based on at least one long-chain alcohol. In embodiments with a plurality of particle layers one above the other, preferably all the particle layers are applied first and then the film is formed jointly and/or they are crosslinked.

The amount of at least one film-forming aid contained in the aqueous composition—in particular in the bath—may be 0.01 to 50 g/L based on the solids including the active ingredients, preferably 0.08 to 35 g/L, especially preferably 0.2 to 25 g/L. There is a weight ratio of the amount of organic film-forming agent to the amount of film-forming aids in the aqueous composition.

It is often preferable here for the drying, film-forming and/or crosslinking to take place in the temperature range from 5 to 350° C., preferably 80 to 200° C., especially preferably in the temperature range from 150 to 190° C., based on the oven temperature and/or based on the peak metal temperature (PMT). The selected temperature range depends largely on the type and amount of the organic constituents and optionally also the inorganic constituents and optionally also their film-forming temperatures and/or crosslinking temperatures.

The invention preferably relates to a method in which the aqueous composition and/or the organic coating produced from it contains at least one chelating agent for metal cations or a polymer in which the metal cations are modified by being chelated.

The method according to the invention is especially preferably a method in which the aqueous composition and/or the organic coating produced from it contains at least one chelating agent selected from those based on maleic acid, alendronic acid, itaconic acid, citraconic acid or mesaconic acid or the anhydrides or hemiesters of these carboxylic acids.

The aqueous composition and/or the organic coating produced from it advantageously contain(s) at least one emulsifier.

It is especially preferable for the aqueous composition and/or the organic coating produced from it to contain at least one emulsifier.

The aqueous composition and/or the organic coating prepared from it preferably contain(s) a mixture of at least two different polyelectrolytes.

The aqueous composition and/or the organic coating produced from it especially preferably contain(s) a mixture of two pectins.

Additionally the aqueous composition and/or the organic coating produced from it preferably contain(s) at least one polysaccharide selected from those with a degree of esterification of the carboxyl function in the range of 5 to 75%, based on the total number of alcohol and carboxyl groups.

The aqueous composition and/or the organic coating produced from it most especially preferably contain(s) at least one polysaccharide and/or at least one additional polyelectrolyte selected from those with a molecular weight in the range of 500 to 1,000,000 g/mol⁻¹.

The aqueous composition and/or the organic coating produced from it preferably contain(s) at least one polysaccharide and/or at least one additional polyelectrolyte selected from those with a degree of amidation of the carboxyl functions in the range of 1 to 50%, a degree of epoxidation of the carboxyl functions of up to 80%.

In the method according to the invention, it is especially preferable for the polyelectrolytes to be modified with adhesion-promoting adhesion groups selected from the group consisting of chemical groups of multifunctional epoxies, isocyanates, primary amines, secondary amines, tertiary amines, quaternary amines, amides, imides, imidazoles, formamides, Michael reaction products, carbodiimides, carbenes, cyclic carbenes, cyclocarbonates, multifunctional carboxylic acids, amino acids, nucleic acids, methacrylamides, polyacrylic acids, polyacrylic acid derivatives, polyvinyl alcohols, polyphenols, polyols with at least one alkyl radical and/or aryl radical, caprolactam, phosphoric acids, phosphoric acid esters, epoxy esters, sulfonic acids, sulfonic acid esters, vinyl sulfonic acids, vinyl phosphonic acids, catechol, silanes as well as the silanols or siloxanes formed therefrom, triazines, thiazoles, thiazines, dithiazines, acetals, hemiacetals, quinones, saturated fatty acids, unsaturated fatty acids, alkyds, esters, polyesters, ethers, glycols, cyclic ethers, crown ethers, anhydrides as well as acetyl acetones and beta-diketo groups, carbonyl groups and hydroxyl groups.

Al, Cu, Fe, Mg, Ca and/or Zn are advantageously selected as cations that are dissolved out of the metallic surface and/or are added to the aqueous composition.

The aqueous composition and/or the organic coating produced from it especially preferably contain(s) at least one additive selected from additives consisting of the group of biocides, dispersants, film-forming aids, acidic and/or basic aids for adjusting the pH, thickeners and flow control agents.

Before bringing the metallic surfaces in contact with an aqueous composition and coating them in methods step II, the metallic surfaces are most especially preferably cleaned, pickled and/or pretreated.

The aqueous composition advantageously forms a coating based on an ionogenic gel in which the dry film formed then or later has a thickness of at least 1 μm.

The organic coating is especially preferably formed in 0.05 to 20 minutes in an electro-dip coating bath and has a dry film thickness in the range of 5 to 100 μm after drying.

The invention also relates to an aqueous composition which contains at least one polyelectrolyte in an amount of 0.01 to 5.0% by weight, based on the total weight of the resulting mixture, in a dispersion of film-forming polymers and/or a suspension of film-forming inorganic particles with a solids content of 2 to 40% by weight and an average particle size of 10 to 1000 nm, wherein the aqueous composition has a pH in the range of 4 to 11.

The aqueous composition is preferably one which contains organic particles based on polyacrylates, polyurethanes, polyepoxides and/or their hybrids, at least one chelating agent selected from those based on maleic acid, alendronic acid, itaconic acid, citraconic acid or mesaconic acid or anhydrides or hemiesters of these carboxylic acids and at least one polyelectrolytes based on pectins or gellan gum in a dispersion of film-forming polymers.

It has been found that closed or essentially closed coatings with a layer thickness in the range of 5 nm to 50 μm, in particular in the range of 10 nm to 40 μm, preferably 15 nm to 1 μm, can be produced from the surfaces coated according to the invention. The individual coatings may have corresponding layer thicknesses before and/or after formation of the film and/or before their crosslinking.

It has been found that the surfaces coated according to the invention from which subsequently closed or essentially closed coatings are produced can be produced by a greatly simplified and much less expensive method than, for example, coatings produced as electro-dip coatings, autophoretic immersion coatings or powder coatings.

Furthermore it has been found that such coatings produced according to the invention may be equivalent in their properties to electro-dip coatings, autophoretic immersion coatings or powder coatings according to today's industrial practice.

It has surprisingly been found that the method according to the invention, which is not or is essentially not an electrolytic process, can be operated more easily and without complex control measures even in the case when it is supported slightly with electrical voltage, and therefore it is not necessary in general to apply an external electrical voltage. This method can be used in a wide temperature range and also at room temperature apart from the subsequent drying.

It has also been found that in the method according to the invention, no complex control measures are required with respect to the application of the activating means in order to achieve a uniform and homogenous coating and that high quality protective follow-up coatings are formed with low consumption of chemicals, the coatings achieving a thickness in the range of 500 nm to 30 μm.

It is surprising that the method according to the invention is a self-regulating method with regard to the deposition of the follow-up coating in particular, forming high quality protective coatings with low consumption of chemicals and without requiring any complex control measures.

In addition, it has been found that the follow-up coatings deposited according to the invention form a homogenous layer with a uniform dry layer thickness on a workpiece having a complex shape, comparable to the quality of a paint layer deposited by traditional electrophoretic or autophoretic methods.

The inventive coating may preferably be used for coated substrates such as wires, braided wires, strips, sheets, sections, linings, parts of a vehicle or airplane, elements for household appliances, elements in construction, frames, guide rails, heating elements or fence elements, molded parts with a complicated geometry or small parts such as screws, nuts, flanges or springs. These coatings are especially preferably used in automotive engineering, construction, instrument design, for household appliances or in heating construction. Use of the method according to the invention is especially preferred for coating substrates which have posed problems in coating by electro-dip coating.

The invention will now be explained in greater detail below on the basis of four exemplary embodiments and ten comparative examples, in which the following were used as the substrates in step I:
1. Electrolytically galvanized steel plate with an applied zinc layer thickness of 5 μm, sheet metal thickness 0.81 mm;
2. Cold rolled steel, sheet metal thickness approx. 0.8 mm;
3. Aluminum alloy of quality class AC 170, sheet metal thickness approx. 1.0 mm and the following general treatment steps were carried out:

II. Alkaline Cleaning:

Industrial alkaline cleaner, for example, 30 g/L Gardoclean® S 5176 and 4 g/L Gardobond® additive H 7406 of Chemetall GmbH is prepared in water, preferably in tapwater or potable water. The metal sheets were cleaned by spraying at 60° C. for 180 sec and then rinsed for 120 sec with tapwater and rinsed by dipping in deionized water for 120 sec.

III. Coating the Surfaces with the Dispersions According to the Invention to Form the Organic Coating:

Composition of Dispersion A

DPE dispersion in maleic acid
NV_{theoretical} = 40%
NV_{practical} = 39%

| | |
|---|---|
| Chemical | (g) |

Step 1

| | |
|---|---|
| H₂O | 770 |
| NH₃ (25%) | 6.24 |
| MA | 5.06 |
| DPE | 2.0531 |
| MMA | 25.05 |
| APS | 3.12 |
| H₂O | 67.6 |

Step 2

| | |
|---|---|
| BMA | 500 |
| HEMA | 25 |

List of Abbreviations:

NH₃ Ammonia solution (25%)

AA Acrylic acid

DPE Diphenylethylene

MMA Methyl methacrylate

APS Ammonium peroxodisulfate

BMA Butyl methacrylate

HEMA Hydroxyethyl methacrylate

MA Maleic acid

VTES Vinyl triethoxysilane

NV Nonvolatile fraction (corresponds to solids content)

Dispersion B

Anionically stabilized dispersion with a film-forming temperature of 25° C., a solids content of 49-51%, a pH of 7.0-8.0, a viscosity of 20-200 mPas, a density of 1.04 g/cm³, a particle size of approx. 160 nm and −14 to −18 mV. The dispersion is adjusted to a solids content of 10% using deionized water for the remaining course of treatment.

Dispersion C

A nonionically stabilized dispersion with a solids content of 50-54%, a pH of 5.0-6.0, a viscosity of 1500-3000 mPas and a density of 1.079 g/cm³. The data in the table is based on the amount of solution per liter of formulation, and the resulting solids content is based on the formulation. The dispersion is adjusted to a solids content of 10% for the further treatment process using deionized water.

Only dispersion A without the addition of the polyelectrolytes being considered for the use according to this invention was used for the Comparative Examples 1 to 3. If necessary, the mixture was adjusted to a pH of 4 prior to use by adding acid, preferably nitric acid and/or phosphoric acid. For Comparative Examples 4 to 6, only the polyelectrolytes being considered for the use according to the invention were used. In Comparative Example 7, all the ingredients of the aqueous solution according to the invention, except for the complex fluorides, were used.

IV. Rinsing the Organic Coating:

Rinsing after the organic coating serves to remove non-adhering ingredients of the formulation and accumulations of the formulation and to make the process as realistic as possible and close to that customarily carried out in the automotive industry because, in the automotive industry, rinsing with water is usually done either by an immersion rinse or by a spray rinse.

V. Drying and/or Crosslinking the Coating:

Drying or drying with film formation of the organic polymeric ingredients in particular: 1751 for 15 minutes. Parallel studies with eddy current measurements and scanning electron microscopy (SEM) have shown that the coatings formed according to the invention were closed or mostly closed coatings formed by bringing the surfaces in contact with dispersions and/or formulations.

### EXAMPLE 1

Substrate 1 was mixed with a mixture of 0.25% by weight, based on the total amount of the resulting mixture, with a pectin with a molecular weight of approx. 70,000 g/mol, a degree of amidation of 0%, a degree of esterification of 52%, a degree of epoxidation of 0%, a galacturonic acid content of 87% and 0.25% by weight, based on the total amount of the resulting mixture, and a pectin with a molecular weight of approx. 70,000 g/mol, a degree of amidation of 0%, a degree of esterification of 10%, a degree of epoxidation of 0%, a galacturonic acid content of 85% with 99.5% by weight of dispersion C described above was mixed with a mixture of 0.25% by weight. Then 10.0 g/L 20% hexafluorozirconic acid was added to this mixture. A dry film with a thickness of 20 μm to 25 μm was measured using an eddy current meter and SEM.

### EXAMPLE 2

Experiment 1 was repeated using substrate 2 and a dry film thickness of 20 μm to 25 μm was found by SEM.

### EXAMPLE 3

Experiment 1 was repeated with substrate 3 and a dry film thickness of 5 μm to 10 μm was determined by SEM.

### EXAMPLE 4

Substrate 3 was mixed with a pectin having a molecular weight of approx. 70,000 g/mol, a degree of amidation of 0%, a degree of esterification of 52%, a degree of epoxidation of 0%, a galacturonic acid content of 87% and 0.25% by weight, based on the total amount of the resulting mixture, a pectin with a molecular weight of approx. 70,000 g/mol, a degree of amidation of 0%, a degree of esterification of 10%, a degree of epoxidation of 0%, a galacturonic acid content of 85% with 99.5% by weight of dispersion C, mixed with a mixture of 0.25% by weight, based on the total amount of the resulting mixture. Then 10.0 g/liter 20% hexafluorotitanic acid was added to the mixture. A dry film thickness of 8 μm to 10 μm was measured using an eddy current meter and SEM.

### COMPARATIVE EXAMPLE 1

Substrate 1 was coated with dispersion A. No dry film thickness was determined by SEM.

### COMPARATIVE EXAMPLE 2

Substrate 2 was coated with dispersion A. No dry film thickness was determined by SEM.

### COMPARATIVE EXAMPLE 3

Substrate 3 was coated with dispersion A. No dry film thickness was determined by SEM.

### COMPARATIVE EXAMPLE 4

Coating of substrate 1 with the polyelectrolytes mentioned in the description of the invention without mixing with the dispersion A yielded a dry film thickness of 300 nm to 500 nm.

### COMPARATIVE EXAMPLE 5

Coating of substrate 2 with the polyelectrolytes mentioned in the description of the invention without mixing it with dispersion A, yielded a dry film thickness of 300 nm to 500 nm.

### Comparative Example 6

The coating of substrate 3 with the polyelectrolytes mentioned in the description of the invention without mixing it with dispersion A yielded a dry film thickness of 300 nm to 500 nm.

### COMPARATIVE EXAMPLE 7

Substrate 3 was coated by immersion in a mixture of 0.25% by weight, based on the total amount of the resulting mixture with a pectin with a molecular weight of approx. 70,000 g/mol, a degree of amidation of 0%, a degree of esterification of 52%, a degree of epoxidation of 0%, a galacturonic acid content of 87% and 0.25% by weight, based on the total amount of the resulting mixture, a pectin with a molecular weight of approx. 70,000 g/mol, a degree of amidation of 0%, a degree of esterification of 10%, a degree of epoxidation of 0%, a galacturonic acid content of 85% with 99.5% by weight of dispersion A described above. No dry film thickness could be detected.

### COMPARATIVE EXAMPLE 8

Substrate 1 was coated with a mixture of 0.25% by weight, based on the total amount of the resulting mixture with a pectin with a molecular weight of approx. 70,000 g/mol, a degree of amidation of 0%, a degree of esterification of 52%, a degree of epoxidation of 0%, a galacturonic acid content of 87% and 0.25% by weight, based on the total amount of the resulting mixture, a pectin with a molecular weight of approx. 70,000 g/mol, a degree of amidation of 0%, a degree of esterification of 10%, a degree of epoxidation of 0%, a galacturonic acid content of 85% with 99.5% by weight of the dispersion B described above. 2.0 g/L 20% hexafluorozirconic acid was added to this mixture, forming a dry film with a thickness of 55 μm to 65 μm, measured using an eddy current meter and SEM.

### COMPARATIVE EXAMPLE 9

Comparative Example 8 was repeated with substrate 2 and a dry film thickness of 15 μm to 25 μm determined by SEM.

### COMPARATIVE EXAMPLE 10

Comparative Example 8 was repeated with substrate 3 and a dry film thickness of 3 μm to 4 μm determined by SEM.

The micrographs all showed a homogenous layer formation, which indicates a reliable self-regulating and readily controllable coating method.

1. A method comprising:
I. Providing a substrate with a purified metal surface,
II. Contacting and coating the metal surface with an aqueous composition in the form of a dispersion and/or suspension to form an organic coating,
III. Optionally rinsing the organic coating, and
IV. Drying and/or baking the organic coating, or
V. Optionally drying the organic coating and applying a similar or additional coating composition as an additional coating prior to drying and/or baking,
characterized in that, in step II, the aqueous composition comprises a complex fluoride, selected from the group consisting of hexa- or tetrafluorides of the elements titanium, zirconium, hafnium, silicon, aluminum and/or boron in an amount in the range of 1.1.10⁻⁶ mol/liter to 0.30 mol/liter, based on the cations, wherein at least one nonionic or anionic-nonionic polyelectrolyte is added in an amount in the range of 0.01 to 5.0% by weight, based on the total weight of the resulting mixture, is added to the nonionically or anionically-nonionically stabilized dispersion of film-forming polymers and/or a suspension of film-forming inorganic particles with a solids content in the range of 2 to 40% by weight and an average particle size in the range of 10 to 1000 nm, which is stable in a pH range of 0.5 to 7.0, wherein the aqueous composition has a pH in the range of 0.5 to 7.0 and forms a coating based on an ionogenic gel which binds cations dissolved out of the metallic surface and these cations originate from a pretreatment step and/or from the contacting in step II.

2. The method according to claim 1, characterized in that a complex fluoride is present in an amount in the range of 1.1.10⁻⁵ mol/liter to 0.15 mol/liter based on the cations, wherein the aqueous composition has a pH in the range of 1.0 to 6.0.

3. The method according to claim 1, characterized in that at least one anionic polyelectrolyte is selected from the groups a) polysaccharides, based on glycogens, amyloses, amylopectins, calloses, agar, algines, alginates, pectins, carrageenans, celluloses, chitins, chitosans, curdlans, dextrans, fructans, collagens, gellan gum, gum arabic, starches, xanthans, gum tragacanth, karayans, tara gum and glucomannans; b) anionic polyelectrolytes of natural origin, based on polyamino acids, collagens, polypeptides, lignins and/or c) synthetic anionic polyelectrolytes, based on polyamino acids, polyacrylic acids, polyacrylic acid copolymers, acrylamide copolymers, lignins, polyvinyl sulfonic acid, polycarboxylic acids, polyphosphoric acids or polystyrenes.

4. The method according to claim 1, characterized in that the anionic polyelectrolyte comprises at least one polysaccharide, based on pectins or gellan gum.

5. The method according to claim 1, characterized in that the aqueous composition and/or the organic coating produced therefrom comprises a mixture of at least two different nonionic or anionic-nonionic polyelectrolytes.

6. The method according to claim 5, characterized in that the aqueous composition and/or the organic coating produced therefrom contain(s) a mixture of two pectins.

7. The method according to claim 1, characterized in that the aqueous composition and/or the organic coating produced therefrom comprises at least one anionic polysaccharide selected from those with a degree of esterification of the carboxyl function in the range of 5 to 75% based on the total number of alcohol and carboxyl groups.

8. The method according to claim 1, characterized in that the aqueous composition and/or the organic coating produced therefrom comprises at least one polysaccharide and/or at least one additional polyelectrolyte selected from those with a molecular weight in the range of 500 to 1,000,000 g/mol⁻¹.

9. The method according to claim 1, characterized in that the aqueous composition and/or the organic coating produced therefrom contain(s) at least one polysaccharide and/or at least one additional polyelectrolyte selected from those with a degree of amidation of the carboxyl functions in the range of 1 to 50%, a degree of epoxidation of the carboxyl functions of up to 80%.

10. The method according to claim 1, characterized in that the polyelectrolytes are modified with adhesion-promoting adhesion groups selected from the group consisting of chemical groups of multifunctional epoxies, isocyanates, primary amines, secondary amines, tertiary amines, quaternary amines, amides, imides, imidazoles, formamides, Michael reaction products, carbodiimides, carbenes, cyclic carbenes, cyclocarbonates, multifunctional carboxylic acids, amino acids, nucleic acids, methacrylamides, polyacrylic acids, polyacrylic acid derivatives, polyvinyl alcohols, polyphenols, polyols with at least one alkyl and/or aryl radical, caprolactam, phosphoric acids, phosphoric acid esters, epoxy esters, sulfonic acids, sulfonic acid esters, vinyl sulfonic acids, vinyl phosphonic acids, catechol, silanes as well as the silanols and/or siloxanes formed therefrom, triazines, thiazoles, thiazines, dithiazines, acetals, hemiacetals, quinones, saturated fatty acids, unsaturated fatty acids, alkyds, esters, polyesters, ethers, glycols, cyclic ethers, crown ethers, anhydrides as well as acetyl acetones and beta-diketo groups, carbonyl groups and hydroxyl groups.

11. The method according to claim 1, characterized in that the aqueous composition and/or the organic coating produced therefrom comprises at least one chelating agent for metal cations or a polymer modified to be a chelating agent for metal cations.

12. The method according to claim 11, characterized in that the aqueous composition and/or the organic coating produced therefrom comprises at least one chelating agent selected from those based on maleic acid, alendronic acid, itaconic acid, citraconic acid or mesaconic acid or the anhydrides or hemiesters of these carboxylic acids.

13. The method according to claim 1, characterized in that the aqueous composition and/or the organic coating produced therefrom comprises at least one type of cation, selected from those based on cationic salts selected from the group consisting of melamine salts, nitroso salts, oxonium salts, ammonium salts, salts with quaternary nitrogen cations, salts of ammonium derivatives and metal salts of Al, B, Ba, Ca, Cr, Co, Cu, Fe, Hf, In, K, Li, Mg, Mn, Mo, Na, Nb, Ni, Pb, Sn, Ta, Ti, V, W, Zn and/or Zr.

14. The method according to claim 13, characterized in that the cations that are dissolved out of the metallic surface or are added to the aqueous composition are selected from Al, Cu, Fe, Mg and/or Zn.

15. The method according to claim 1, characterized in that the aqueous composition and/or the organic coating produced therefrom comprises organic particles based on polyacrylates, polyurethanes, polyepoxides and/or their hybrids.

16. The method according to claim 1, characterized in that the aqueous composition and/or the organic coating produced therefrom comprises at least one emulsifier.

17. The method according to claim 16, characterized in that the aqueous composition and/or the organic coating produced therefrom comprises at least one emulsifier.

18. The method according to claim 1, characterized in that the aqueous composition and/or the organic coating produced therefrom comprises at least one additive selected from of the group consisting of biocides, dispersants, film-forming aids, acidic or basic aids for adjusting the pH, thickeners and flow control agents.

19. The method according to claim 1, characterized in that the aqueous composition forms the coating based on an ionogenic gel, and a dry film formed then or later has a thickness of at least 1 μm.

20. The method according to claim 1, characterized in that the organic coating is formed in 0.05 to 20 minutes in a dip coating bath and after drying has a dry film thickness in the range of 5 to 100 μm.

21. An aqueous composition comprising in an anionically stabilized dispersion of film-forming polymers and/or a suspension of film-forming inorganic particles with a solids content in the range of 2 to 40% by weight and an average particle size in the range of 10 to 1000 nm, which is stable in the pH range of 0.5 to 7.0, at least one polyelectrolyte in an amount in the range of 0.01 to 5.0% by weight, based on the total amount of the resulting mixture as well as a complex fluoride selected from the group consisting of hexafluorides or tetrafluorides of the elements titanium, zirconium, hafnium, silicon, aluminum and/or boron in an amount in the range of 1.1.10⁻⁶ mol/liter to 0.30 mol/liter, based on the cations, wherein the aqueous composition has a pH in the range of 4 to 11.

22. The aqueous composition according to claim 21, characterized in that the dispersion of film-forming polymers comprises organic particles based on polyacrylates, polyurethanes, polyepoxies and/or their hybrids, further comprises at least one chelating agent, selected from those based on maleic acid, alendronic acid, itaconic acid, citraconic acid or mesaconic acid or anhydrides or hemiesters of these carboxylic acids and further comprises at least one anionic polyelectrolyte based on pectins or gellan gum.

23. The method according to claim 1, wherein the substrate was previously unsuccessfully coated by electro-dip coating.
